(19) United States
(12) Patent Application Publication
(10) Pub. No.: US 2019/0082885 A1
(43) Pub. Date: Mar. 21, 2019

(54) AN AIR-FRYING COOKER AND A METHOD OF CLEANING AN AIR-FRYING COOKER

(71) Applicant: KONINKLIJKE PHILIPS N.V., EINDHOVEN (NL)

(72) Inventor: MART KORNELIS-JAN TE VELDE, EINDHOVEN (NL)

(73) Assignee: KONINKLIJKE PHILIPS N.V., EINDHOVEN (NL)

(21) Appl. No.: 16/082,426

(22) PCT Filed: Mar. 7, 2017
(86) PCT No.: PCT/EP2017/055231

§ 371 Date: Sep. 5, 2018

(30) Foreign Application Priority Data
Mar. 9, 2016 (EP) 16159310.8

(51) Int. Cl. A47J 37/06

(52) U.S. Cl. CPC A47J 37/0641; A47J 37/0664

(57) ABSTRACT

An air frying cooker is disclosed. It comprise a chamber (2), a heater (3) disposed in the chamber (2) to heat air in the chamber (2), a fan (4) disposed in the chamber (2) and being rotatable to circulate heated air in the chamber (2) to cook food in the chamber (2) in a cooking mode. The fan (4) is rotatable at a speed of no less than 2500 rpm to generate a circulating air flow within the chamber in a cleaning mode so that the air flows across a surface of an amount of cleaning fluid (8) introduced into the bottom of the chamber (2) to entrain the cleaning fluid in the circulating air flow to clean the chamber (2).

### FIELD OF THE INVENTION

The present invention relates to an air-frying cooker and to a method of cleaning the chamber of an air-frying cooker after the air-frying cooker has been used to cook food in a circulating flow of hot air.

### BACKGROUND OF THE INVENTION

An air-frying cooker cooks food in hot air that is circulated within a cooking chamber at high speed using a fan. The rapid circulation of air increases heat transfer to the food resulting in shorter cooking times. The rapidly circulating hot air enables food to be fried in air instead of being submerged in fat/oil, as is the case with deep fat frying. U.S. Pat. No. 6,201,217 discloses an electric cooker with a fan that is preferably driven at a speed in the range of 2500 rpm to create an even temperature in the oven.

The internal surfaces and components of an air-frying cooker must be periodically cleaned. This includes the walls of the cooking chamber which receives the food to be cooked but also other components such as the heater, fan and any baffles or guides that are located in the chamber and circulate the flow of hot air within the chamber. The internal cleaning of an air-frying cooker can be an onerous task.

### SUMMARY OF THE INVENTION

It is an object of the invention to provide an air-frying cooker that has a cleaning function which substantially alleviates or overcomes one or more of the problems mentioned above. A method of cleaning the chamber of an air-frying cooker is also provided. The invention is defined by the independent claims. The dependent claims define advantageous embodiments.

According to the present invention, there is provided an air-frying cooker comprising a chamber, a heater disposed in the chamber to heat air in the chamber, a fan disposed in the chamber and being rotatable to circulate heated air in the chamber to cook food in the chamber in a cooking mode, wherein the fan is rotatable at a sufficiently high speed to generate a circulating air flow within the chamber in a cleaning mode to entrain a cleaning fluid introduced into the chamber in the circulating air flow, to clean the chamber. The cleaning fluid may for instance be introduced into a bottom of the chamber. In such case, the fan may be rotated to have air flow along a surface of the cleaning fluid with sufficient speed to entrain said cleaning fluid in the air flow. The fan may for instance be rotated at a speed of no less than 2500 rpm. By rotating the fan at a speed of no less than 2500 rpm in the presence of cleaning fluid placed in the bottom of the chamber, it has been found that the circulating air flowing over the surface of the cleaning fluid is flowing at a sufficient speed to entrain the cleaning fluid, thereby spreading the cleaning fluid around the chamber to effectively clean the chamber. The high air speed means that the air can effectively entrain more water. The higher the air speed, the larger the water droplet size (diameter) that can be entrained.

Preferably, the fan is rotatable at a speed of between 2700 rpm and 3500 rpm to entrain cleaning fluid in the circulating air flow to clean the chamber. At these speeds, the cleaning fluid is even more effectively entrained in the circulating air flow.

The fan may be rotatable at a different speed, e.g. a lower speed when it is in a cooking mode than when it is in a cleaning mode. It may not be necessary to rotate the fan at a higher speed during a cooking mode, thereby energy can be saved by rotating the fan at the higher speed only during the cleaning mode.

The fan may be rotatable at a speed of less than 2500 rpm in a cooking mode.

In a preferred embodiment, the air-frying cooker comprises a controller and a user interface and the controller is configured to rotate the fan at a speed of no less than 2500 rpm in response to a signal initiated by a user via the user interface. By providing a controller and a user-interface, a user may easily initiate a cleaning mode after introducing cleaning fluid into the chamber.

Preferably, a seal is provided for sealing the chamber prior to rotating the fan at a speed of no less than 2500 rpm in said cleaning mode. By providing a seal, leakage of cleaning fluid is prevented. Furthermore, entrainment of the cleaning fluid in the air flow can be improved.

According to another aspect of the invention, there is provided an air-frying cooker comprising a chamber, a heater disposed in the chamber to heat air in the chamber, a fan disposed in the chamber and being rotatable to circulate heated air in the chamber to cook food in the chamber in a cooking mode, and an air flow control element positionable in the chamber spaced from a surface of an amount of cleaning fluid introduced into the bottom of the chamber in a cleaning mode, so that when the fan is rotated to generate a circulating air flow within the chamber, the air flow is ducted through a gap between the flow control element and said surface to entrain the cleaning fluid in the circulating air flow to clean the chamber.

By positioning an air flow control element in the chamber, the air may be accelerated over the surface of the cleaning fluid so that it is entrained more readily.

Preferably, the flow control element comprises a plate having a hole therethrough, the plate being operable to direct air that has flowed over the surface of said cleaning fluid through the hole and in a direction away from said surface.

The air-frying cooker may comprise a food receiving container having a bottom wall, the food receiving container being positionable in the chamber and the plate being positionable in the food receiving container so that it extends across said bottom wall above the surface of the cleaning fluid.

By placing the plate in the food receiving container, the plate is supported and spaced from the surface of the cleaning fluid.

The flow control element may comprise a funnel that diverges away from said plate, the funnel being positioned such that air flowing through the hole passes up through the funnel.

The funnel helps to further control the air flow and entrained fluid as it circulates within the chamber.

Preferably, a seal is provided for sealing the chamber after placing said air flow control element in the chamber. The seal prevents leakage of cleaning fluid and can also improve entrainment.

According to the present invention, there is also provided a method of cleaning a chamber of an air-frying cooker comprising a heater disposed in the chamber to heat air in the chamber, and a fan disposed in the chamber and being rotatable to circulate heated air in the chamber to cook food in the chamber in a cooking mode, wherein the method includes:
initiating a cleaning mode by rotating the fan at a speed of no less than 2500 rpm to generate a circulating air flow within the chamber so that the air flows across a surface of an amount of cleaning fluid introduced into the bottom of the chamber to entrain the cleaning fluid in the circulating air flow to clean the chamber.

Preferably, the method comprises rotating the fan at a speed of between 2700 and 3500 rpm in the cleaning mode.

According to another aspect of the present invention, there is also provided a method of cleaning a chamber of an air-frying cooker comprising a heater disposed in the chamber to heat air in the chamber, a fan disposed in the chamber and being rotatable to circulate heated air in the chamber to cook food in the chamber in a cooking mode, the method including the step of initiating a cleaning mode by placing an air flow control element in the chamber spaced from a surface of an amount of cleaning fluid introduced into the bottom of the chamber, and rotating the fan to generate a circulating air flow within the chamber that is ducted through a gap between the flow control element and said surface to entrain the cleaning fluid in the circulating air flow to clean the chamber.

If the air-frying cooker comprises a food container having a bottom wall, and the flow control element comprises a plate having a hole therein, the method may then include the step of placing the plate on the bottom wall of the food container so that it extends across the bottom wall above the surface of the cleaning fluid.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawing, in which:

FIG. 1 shows a cross-sectional side elevation of an air-frying cooker according to an embodiment of the invention.

### DETAILED DESCRIPTION OF THE EMBODIMENTS

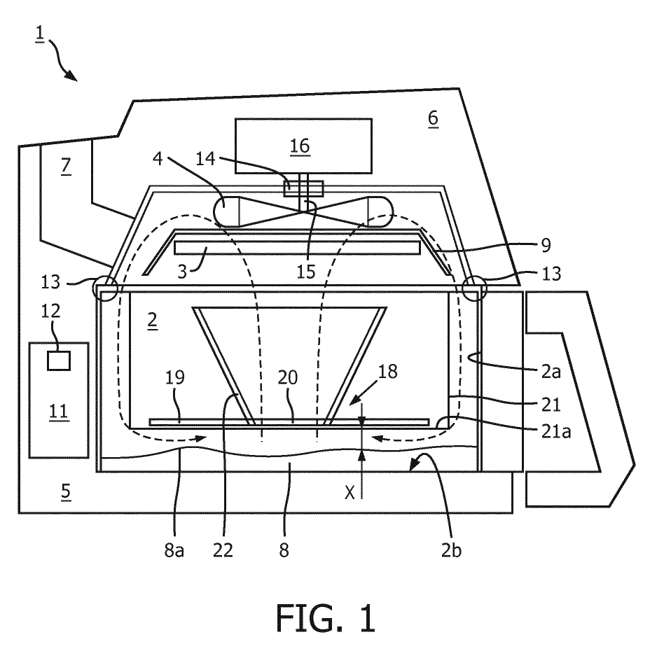

An embodiment of an air-frying cooker 1 according to the invention is shown in FIG. 1 and comprises a chamber 2, a heater 3 to heat air in the chamber 2, and a fan 4 to circulate heated air in the chamber 2 to cook food placed in the chamber 2 during a cooking mode. The heater 3 and the fan 4 are disposed inside the chamber, close to its upper end. The air-frying cooker 1 may have a base 5 and a lid 6 which together define the chamber 2. The heater 3 and the fan 4 may be contained within the lid 6. A vent 7 permits air to flow from the chamber 2 to outside during a cooking mode although there is only minimal flow through the vent 7 when steam is generated during cooking or in the event that a lot of air leaks in through gaps in the cooking chamber 2.

During a cooking mode, in which the food placed in the chamber 2 is cooked in a circulating flow of hot air in the chamber 2, the chamber 2 is not sealed and heated air can escape through the vent 7.

The chamber 2 needs to be cleaned periodically to remove residue or other dirt that may accumulate on the walls of the chamber 2 and on the surfaces of the heater 3 and fan 4 located in the chamber 2. A cleaning mode may be initiated after every time the air-frying cooker 1 has been used to cook food or, only after it has been used to cook food a number of times.

To automatically clean the air-frying cooker 1 after any cooked food has been removed, a user introduces a cleaning fluid 8 into the chamber 2 so that it at least completely covers the bottom of the chamber 2, but preferably to a depth of at least 1-2 cm or thereabouts. As the fan 4 and heater 3 are mounted at an upper part of the chamber 2, they are spaced from the surface 8a of the cleaning fluid 8 introduced into the chamber 2. Once the cleaning fluid 8 has been introduced into the chamber 2, the chamber 2 may be sealed by closing the lid 6. The vent 7 does not need to be blocked as there is no significant air flow through the vent 7 in the cleaning mode. A cleaning mode is now initiated and the fan 4 is switched on. During a cleaning mode, the speed of the fan 4 is controlled so that it rotates at a sufficiently high speed to entrain the cleaning fluid 8 in the circulating flow of air generated within the chamber 2. By entraining the cleaning fluid, it is lifted up in the air flow and sprayed over the heater 3 and fan 4, as well as over the internal surfaces 2a of the chamber 2 and any other components, such as any air-circulation baffles or guides 9, that are mounted within the chamber 2. The cleaning fluid 8 thereby cleans any accumulated dirt or residue off all these components and surfaces.

As the chamber 2 may be sealed during the cleaning cycle, no cleaning fluid 8 can escape from the chamber 2. Furthermore, the entrainment of the cleaning fluid 8 in the circulating flow of air may be improved. If desired, the heater 3 may also be operated during the cleaning mode to heat the cleaning fluid 8 and the circulating air.

During the cleaning mode, the fan 4 may rotate at a speed of no less than 2500 rpm, but it is preferably rotated at a speed of no less than 2700 rpm and most preferably at a speed of no less than 2500 rpm and no more than 3500 rpm. The fan 4 may be rotated at a different, preferably lower, speed during the cooking mode. For example, the fan 4 may rotate at a speed less than 2500 rpm during the cooking mode.

The air-frying cooker 1 may include a controller 11 configured to rotate the fan 4 at the speed sufficient to circulate cleaning fluid 8. A user may initiate a cleaning cycle via a user interface 12 that sends a signal to the controller 11. A user may be provided with an indication that a cleaning cycle should be initiated after a predetermined number of cooking cycles have been performed.

The lid 6 may form a seal with the base 5 by a sealing member 13 located between them. The sealing member 13 may be made from a flexible and resilient material such as rubber that is located between interfacing surfaces between the lid 6 and the base 5.

The chamber 2 may also be sealed by a sealing element 14 disposed between a drive shaft 15 that extends between the fan 4 and a motor 16 through a wall of the chamber 2 to prevent escape of cleaning fluid 8 along the shaft 15 towards the motor 16.

Optionally, a flow control element 18 may be positioned in the cooking chamber 2 so that it is spaced from a surface 8a of the cleaning fluid 8. The flow control element 18 serves to duct or constrict the circulating flow of air in the chamber 2 through a gap X between the flow control element 18 and the surface 8a of the cleaning fluid 8. By constricting the air flow in this way, it accelerates as it travels over the surface 8a of the cleaning fluid 8 so the fluid is more easily entrained in the circulating air flow. As the cleaning fluid 8 is more easily entrained in the circulating air flow, it is possible to use a lower fan speed so that the cleaning mode can be performed more efficiently and by using less energy. In certain circumstances, it may be possible to rotate the fan 4 at the same speed at which the fan 4 is rotated during a cooking cycle, or even at a speed lower than the speed at which it is rotated during a cooking cycle.

The gap X will vary depending on the size of the cooking chamber 2 and fan speed, but could be in the range of 1 cm-3 cm. Most preferably, the range may be in the order of 2 to 2.7 cm.

In a preferred embodiment, the flow control element 18 comprises a plate 19 having a hole 20 therethrough to direct air that has flowed over the surface 8a of said cleaning fluid 8 in a direction away from said surface 8a through the hole 20, together with the cleaning fluid 8 that is entrained in the air flow. The hole 8 is preferably formed in the centre of the plate 19 so that air is ducted across the surface 8a of the cleaning fluid 8 from all directions towards and up through the hole 20. The underside surface 19a of the plate 19 that faces the surface 8a of the cleaning fluid 8 may be flat so that it extends parallel to the surface 8a of the cleaning fluid 8. However, the underside surface 19a may extend at an angle so that it extends at an angle relative to the surface 8a of the cleaning fluid 8.

The hole 20 in the plate 19 also acts as a constriction so that the air flow, together with the entrained cleaning fluid 8, further accelerates as it passes through the hole 20 and in an upward direction towards the fan 4 and the heater 3 located in the chamber 2 above the plate 19. Accelerating the entrained fluid flow increases cleaning effectiveness as more cleaning fluid is entrained in the air flow. Furthermore, the cleaning fluid 8 impacts the heater 3, fan 4 and other components with greater velocity and force to remove accumulated dirt and residue.

The plate 19 must be located in a position in which it is spaced from the surface 8a of the cleaning fluid 8 in order to duct the flow of air between the plate 19 and the surface 8a of the cleaning fluid 8. To achieve this, the plate 19 may be placed on the bottom wall 21a of a food receiving container 21 that is normally placed in the chamber 2 and used to contain food during a cooking cycle. The bottom wall 21a of the food receiving container 21 is spaced sufficiently from the bottom wall 2b of the chamber 2 to provide the gap X between the plate 19 and the surface 8a when the cleaning fluid 8a has been introduced into the chamber 2.

The plate 19 may be made of aluminum. The hole 20 may also have a diameter in the order of 8 to 9 cm.

To further guide the accelerating air flow and entrained cleaning fluid 8 as it travels in an upward direction through the hole 20 in the plate 19, a funnel 22 may be positioned over the hole 20. The funnel 22 may diverge in a direction away from the hole 20 so that the flow is gradually guided upwardly and radially within the chamber 2. The funnel 22 may be integrally formed with the plate 19 or they may be separate components attachable to each other. In another embodiment, the ‘funnel’ can be a cylindrical tube which helps to move water but the spread of water around the chamber and over the heater may be more limited.

When a user wishes to initiate the cleaning mode, a cleaning fluid 8 is introduced into the chamber 2. The chamber 2 is then sealed and the user may then initiate the cleaning mode via the user interface 12 so that the fan 4 circulates the cleaning fluid 8 around the chamber 2. The fan 4 may continue to run until further intervention by the user. However, the fan 4 preferably continues to run for a predetermined period of time before switching off.

If the flow control element 19 is used, it is placed on the bottom wall 21a of the food receiving basket 21 so that it is spaced from a surface 8a of the cleaning fluid 8, prior to sealing the chamber 2. The air flow generated by operation of the fan 4 will then be ducted through the gap X between the flow control element 19 and the surface 8a of the cleaning fluid 8 and the air flow will be accelerated over the surface 8a of the cleaning fluid 8, thereby entraining the cleaning fluid 8 in the circulating air flow more easily.

After the cleaning mode has finished, the cleaning fluid 8 is drained from the chamber 2. The chamber 2 may also be rinsed and dried using the heater 3.

The cleaning fluid 8 may be water, detergent or a combination of both. Any known types of cleaning agents may also be used. A decalcifying agent may also be introduced into the chamber 2 together with the cleaning fluid 8 to remove any calcified deposits.

The above embodiments as described are only illustrative, and not intended to limit the technique approaches of the present invention. Although the present invention is described in details referring to the preferable embodiments, those skilled in the art will understand that the technique approaches of the present invention can be modified or equally displaced without departing from the spirit and scope of the technique approaches of the present invention, which will also fall into the protective scope of the claims of the present invention. In the claims, the word “comprising” does not exclude other elements or steps, and the indefinite article “a” or “an” does not exclude a plurality. Any reference signs in the claims should not be construed as limiting the scope.

1. An air-frying cooker comprising:
a chamber,
a heater disposed in the chamber to heat air in the chamber,
a fan disposed in the chamber and being rotatable to circulate heated air in the chamber to cook food in the chamber in a cooking mode,
wherein the air-frying cooker comprises a cleaning mode, during which a speed of the fan is controlled so that it rotates at a sufficiently high speed to generate a circulating air flow within the chamber to entrain a cleaning fluid introduced into the chamber in the circulating air flow to clean the chamber.

2. An air-frying cooker according to claim 1, wherein the fan during the cleaning mode is controlled to rotate at a speed of no less than 2500 rpm, preferably at a speed between 2700 rpm and 3500 rpm to entrain cleaning fluid in the circulating air flow to clean the chamber.

3. An air-frying cooker according to claim 1, wherein the fan is controlled to rotate at a different speed during the cooking mode than during the cleaning mode.

4. (canceled)

5. (canceled)

6. (canceled)

7. An air-frying cooker according to claim 1, comprising a controller and a user interface, the controller being configured to rotate the fan at a speed of no less than 2500 rpm in response to a signal initiated by a user via the user interface.

8. An air-frying cooker according to claim 1, comprising a seal for sealing the chamber in said cleaning mode.

9. An air-frying cooker according to claim 1, comprising a sealing element disposed around a drive shaft that extends through a wall of the chamber between the fan and a motor.

10. An air-frying cooker according to claim 1, wherein the cleaning fluid is introduced into the bottom of the chamber and the air flow is controlled to flow along a surface of the cleaning fluid with sufficient speed to entrain said cleaning fluid in the air flow.

11. An air-frying cooker comprising:
a chamber,
a heater disposed in the chamber to heat air in the chamber,
a fan disposed in the chamber and being rotatable to circulate heated air in the chamber to cook food in the chamber in a cooking mode, and
an air flow control element positionable in the chamber spaced from a surface of an amount of cleaning fluid introduced into the bottom of the chamber in a cleaning mode, so that when the fan is rotated to generate a circulating air flow within the chamber, the air flow is ducted through a gap (X) between the flow control element and said surface to entrain the cleaning fluid in the circulating air flow to clean the chamber.

12. An air-frying cooker according to claim 11, wherein the flow control element comprises a plate having a hole therethrough, the plate being operable to direct air that has flowed over the surface of said cleaning fluid through the hole and in a direction away from said surface.

13. An air-frying cooker according to claim 12, comprising a food receiving container having a bottom wall, the food receiving container being positionable in the chamber and the plate being positionable in the food receiving container so that it extends across said bottom wall above the surface of the cleaning fluid.

14. An air-frying cooker according to claim 12, wherein the flow control element comprises a funnel that diverges away from said plate, the funnel being positioned such that air flowing through the hole passes up through the funnel.

15. An air-frying cooker according to claim 11, comprising a seal for sealing the chamber after placing said air flow control element in the chamber.

16. A method of cleaning a chamber of an air-frying cooker comprising a heater disposed in the chamber to heat air in the chamber, and a fan disposed in the chamber and being rotatable to circulate heated air in the chamber to cook food in the chamber in a cooking mode, wherein the method includes:
initiating a cleaning mode by rotating the fan at a speed of no less than 2500 rpm to generate a circulating air flow within the chamber so that the air flows across a surface of an amount of cleaning fluid introduced into the bottom of the chamber to entrain the cleaning fluid in the circulating air flow to clean the chamber.

17. (canceled)

18. A method of cleaning a chamber of an air-frying cooker comprising:
a heater disposed in the chamber to heat air in the chamber,
a fan disposed in the chamber and being rotatable to circulate heated air in the chamber to cook food in the chamber in a cooking mode, the method including the step of:
initiating a cleaning mode by placing an air flow control element in the chamber spaced from a surface of an amount of cleaning fluid introduced into the bottom of the chamber, and
rotating the fan to generate a circulating air flow within the chamber that is ducted through a gap (X) between the flow control element and said surface to entrain the cleaning fluid in the circulating air flow to clean the chamber.

19. A method according to claim 18, wherein the air-frying cooker comprises a food container having a bottom wall, and the flow control element comprises a plate having a hole therein, the method including the step of placing the plate on the bottom wall of the food container so that it extends across the bottom wall above the surface of the cleaning fluid.
